(19) United States
(12) Patent Application Publication
(10) Pub. No.: US 2001/0000610 A1
(43) Pub. Date: May 3, 2001

(54) Apparatus and method for dispensing items from a vending machine

(76) Inventor: David K. Johnson, McGregor, MN (US)

Correspondence Address: SCHAFER LAW OFFICE PA, 727 TORCHWOOD CIRCLE, NEW BRIGHTON, MN, 55112, US

(21) Appl. No.: 09/735,194

(22) Filed: Dec. 8, 2000

Related U.S. Application Data
(63) Continuation-in-part of application No. 09/118,761, filed on Jul. 18, 1998, now abandoned.
(60) Provisional application No. 60/054,117, filed on Jul. 29, 1997.

(51) Int. Cl. G07F 11/42

(52) U.S. Cl. 221/13; 221/126; 221/133; 221/277

(57) ABSTRACT

A vending machine for dispensing items from a plurality of horizontally arranged helical coils including a single dispenser for actuating for rotational movement of a selected helical coil. The machine includes, in a first embodiment, a horizontally positioned threaded bar on which is mounted the dispenser wherein rotation of the threaded horizontal bar re-positions the dispenser along a Y axis. A pair of vertical bars, a first vertical bar having a threaded exterior, rotation of the threaded vertical bar re-positions the horizontal bar with the following dispenser. Light emitters, positioned adjacent each helical coil, signal a receiver mounted on the dispenser assembly for positioning the dispenser in a pre-determined position. Once in position, dispenser is urged from a normal position out of engagement with any helical coil to an second position in engagement with a selected helical coil for actuation of the selected helical coil vending the selected article. A second embodiment also utilizes a single dispenser having a single vend motor, the dispenser mounted for horizontal movement on an I-shaped support. Vertical movement is accomplished by a pulley system mounted on the I-shaped support that moves the dispenser vertically in response to electronic signals received by the controller board.

1. This application is a continuation in part application of Ser. No. 09/118,761 filed under 35 U.S.C. §111(a), which replaced the provisional application Ser. No. 60/054,117 filed Jul. 29, 1997 under 35 U.S.C. §111(b). Applicant claims benefit of the earlier filing date under 35 U.S.C. §120.

### BACKGROUND

2. This invention relates generally to the field of dispensing apparatuses such as vending machines of the type for dispensing food or other articles and specifically to an improved vending machine operating system including a single vend motor for the operation of the entire vending machine apparatus.

3. Prior art vending machines have used helical coils as an article storage device. In each of these prior vending machines, a vend motor was required for operation of each helical coil. Because of the great numbers of vend motors required in these prior art vending machines, to keep the vending machine economical to produce, low cost motors were used. These low cost motors frequently needed repair or replacement. Repair of these machines has been found to be costly. Repair of these machines has also been found to be dangerous to the repair person because a great number of circuits would be encountered, due to the numbers of motors, and because these vend motors generally are accessible only from the rear of the machine.

4. Other prior arts have employed use of an X-Y support system that employs a series of positive brake motors, mounted on a series of shafts, that in turn drive an actuator that includes a clutch plate that engages a corresponding clutch plate mounted to one end of a dispensing helical coil. When actuated, this dispensing system either pushes the article or the helical coil rather than rotates the helical coil. While these units may be suitable for the particular purpose to which they address, they would not be as suitable for the purposes of the present invention as heretofore described.

5. A vending machine using a single vend motor to engage and drive one of a plurality of helical coils, or other vend dispensing systems, would be an improvement. Additionally, a single vend motor mounted on a dispenser which has easy access for repair, would be a further improvement. Because only one vend motor is required, a higher quality motor, presumably needing less frequent repair, is used without compromising economical production, would be an additional improvement. Additionally, by providing a back-up vend motor within the vending machine easily powered by a switch to quickly replace a faulty vend motor, would provide a further improvement. Additionally, providing a dispenser that is brake-free simplifies the system and makes it more economical both to manufacture and to repair.

### SUMMARY

6. The present invention is directed to a vending machine that satisfies these needs for a vending machine that is less expensive to purchase and operate and is easier to repair when repair is needed. A vending machine having features of the present invention comprises a cabinet having a plurality of helical coils or shelves positioned generally horizontally within the cabinet as supporting means for receiving articles to be dispensed. An easily accessible single vend motor, mounted for movement on a dispenser within said cabinet, is provided for actuating a pre-determined helical coil to dispense an article. Means are provided for moving the vend motor carrying dispenser to a position adjacent a selected helical coil. These means include, in a first embodiment, a vertical threaded rod, positioned for rotational movement within the cabinet, and a horizontal threaded rod mounted for rotational movement to support the vend motor carrying dispenser, mounted for movement adjacent the threaded vertical rod. A first drive motor drives the threaded vertical rod for rotation in a vertical plane changing vertically the position of the horizontal rod and dispenser with vend motor mounted thereon. A second drive motor drives the threaded horizontal rod for rotation in a horizontal plane changing horizontally the position of the dispenser with vend motor mounted thereon. Actuation means actuates each drive motor moving the vend motor carrying dispenser to a predetermined position. Signal means, actuated by an LED, sends a signal to indicate when the dispenser is in a selected position, and are received by a receiver. Once in position, additional actuation means actuates the vend motor on the dispenser rotating the selected helical coil for dispensing the article.

7. In a second embodiment, the means for moving the vend motor carrying dispenser include a generally I-shaped support which moves along a horizontal track along the bottom of the vending machine. The I-shaped support is also supported at a top edge by a horizontal bar. The vend motor, mounted on the dispenser, is moved in response to electronic signals from a controller circuit board. Once in position, a solenoid urges the vend motor, mounted on the dispenser, into engagement with the selected helical coil and the helical coil is rotated resulting in vending of the selected article. In the second embodiment, the controller circuit board eliminates the need for sensors, including emitters and receivers.

### BRIEF DESCRIPTION OF THE DRAWINGS

8. Understanding of the invention will be enhanced by referring to the accompanying drawings, in which like numbers refer to like parts in the several views and in which:

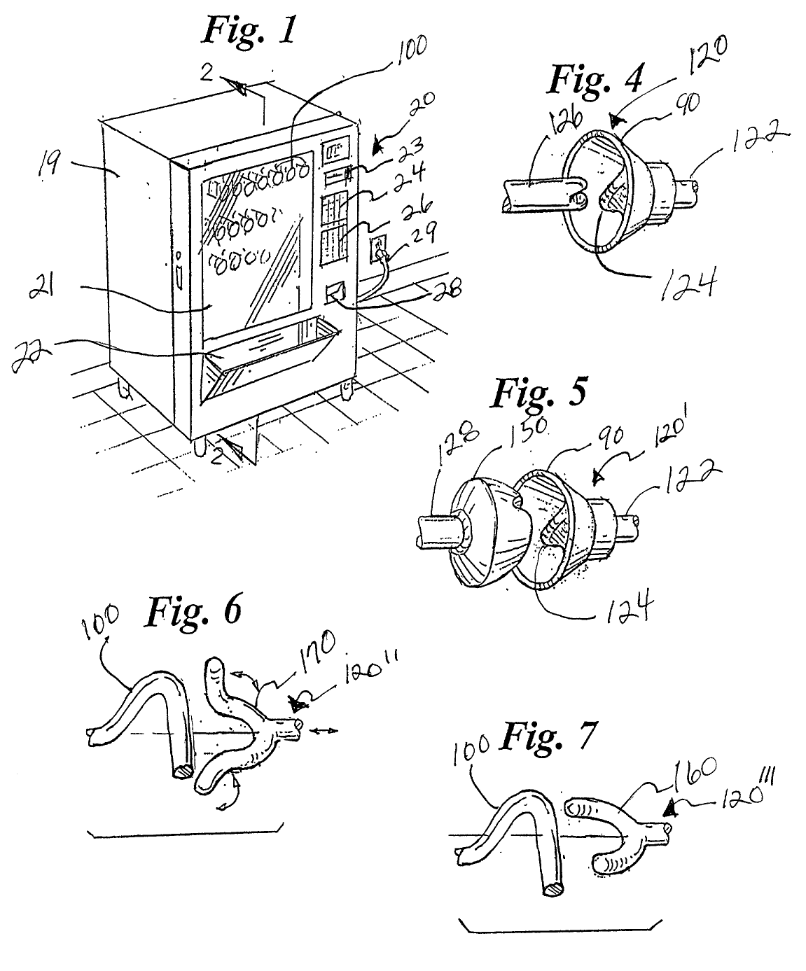

9. FIG. 1 is a perspective view of a typical coordinate selectable vending machine;

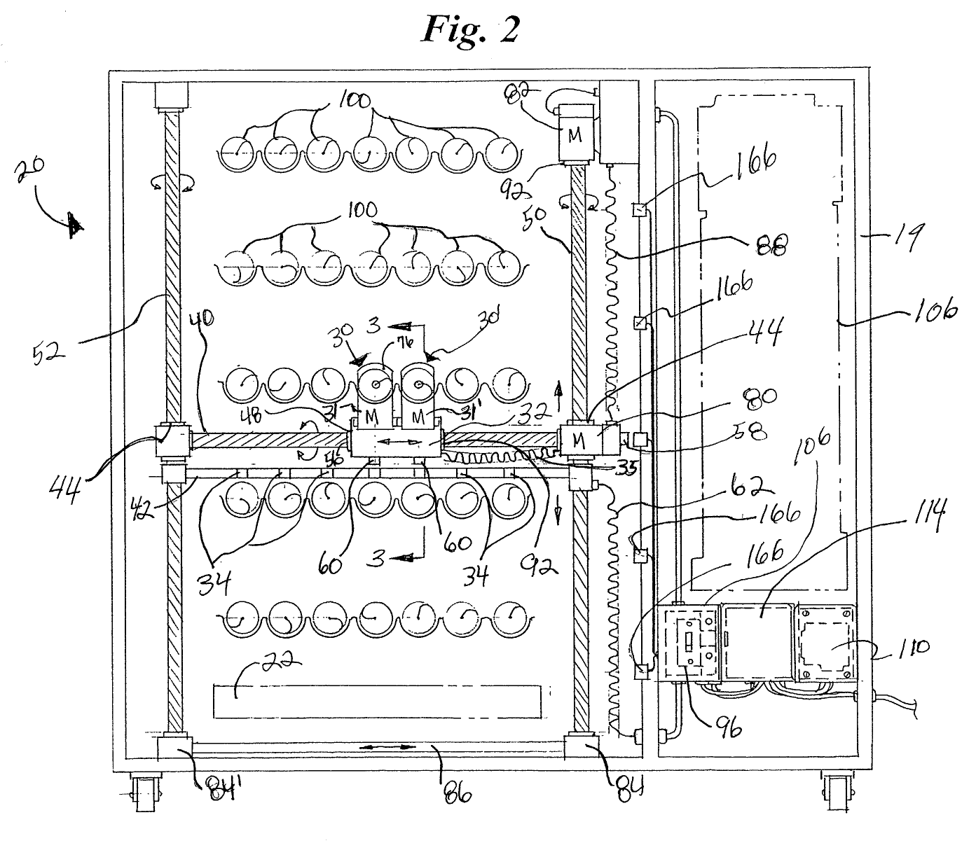

10. FIG. 2 is a simplified internal view of the first embodiment coordinate selectable vending machine of the present invention;

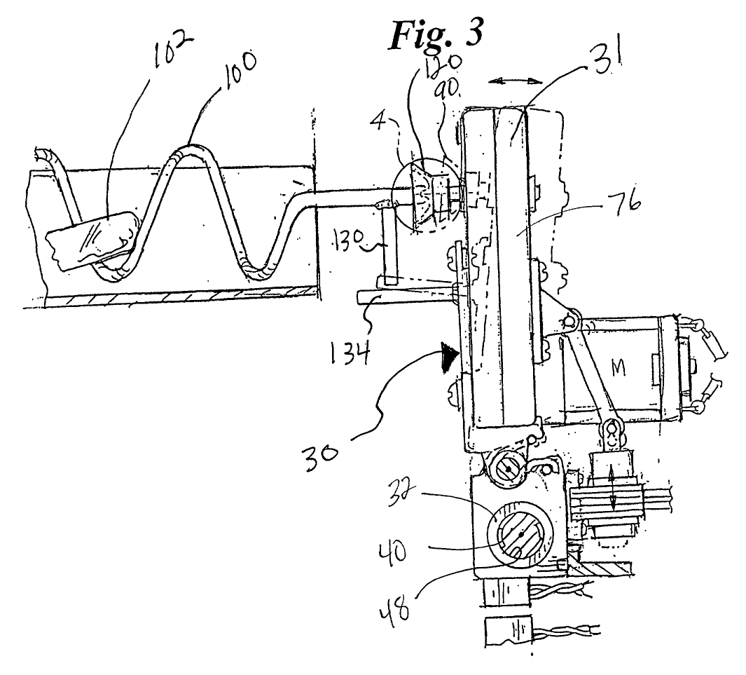

11. FIG. 3 is a close-up view of the motorized dispenser of the present invention taken along the lines 3—3 in FIG. 2;

12. FIG. 4 is a first embodiment helical coil/dispenser docking system;

13. FIG. 5 is a first embodiment alternate helical coil/dispenser docking system;

14. FIG. 6 is a first embodiment alternate helical coil/dispenser docking system;

15. FIG. 7 is a first embodiment alternate helical coil/dispenser docking system;

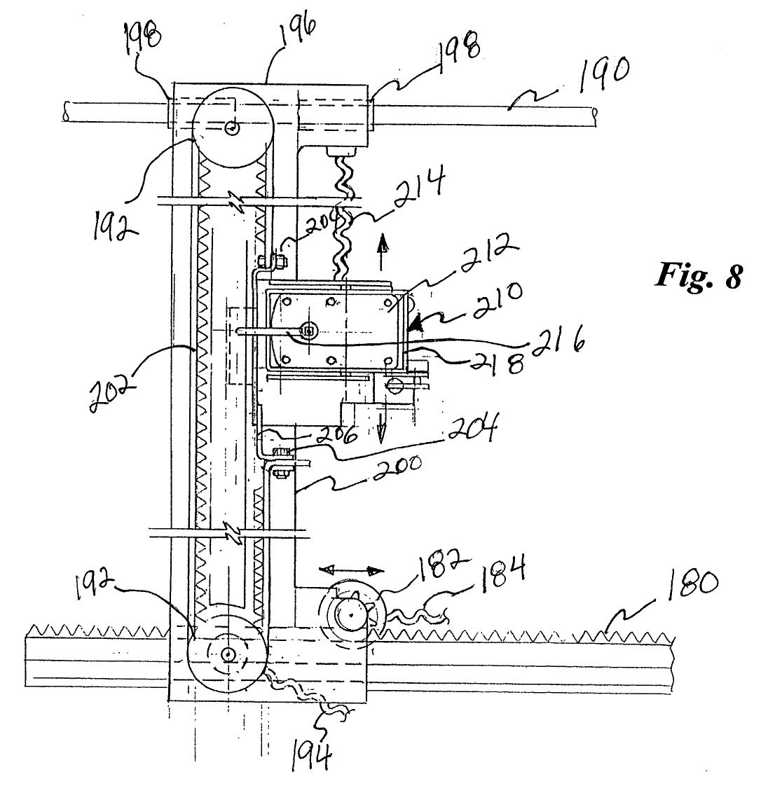

16. FIG. 8 is a simplified internal view of the second embodiment coordinate selectable vending machine of the present invention;

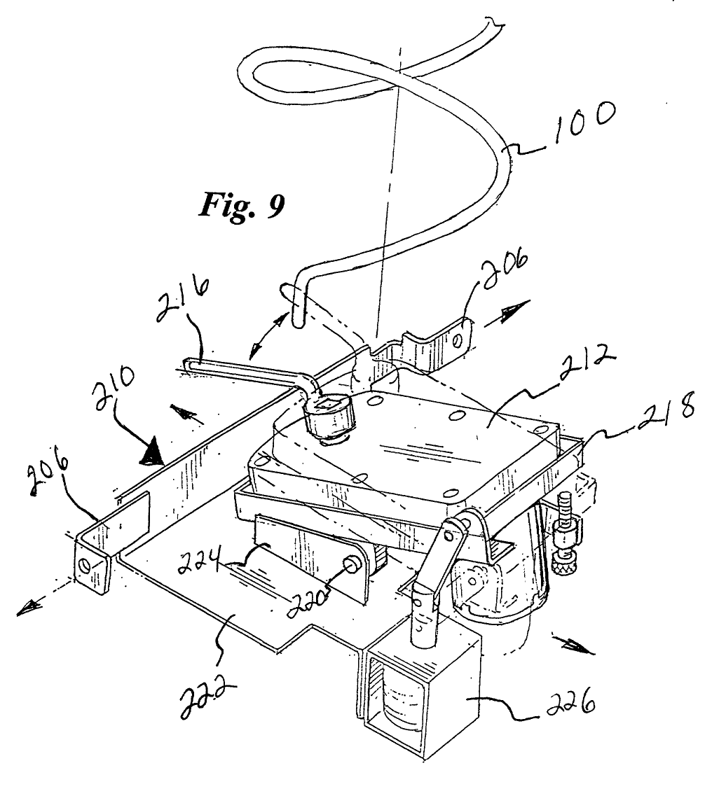

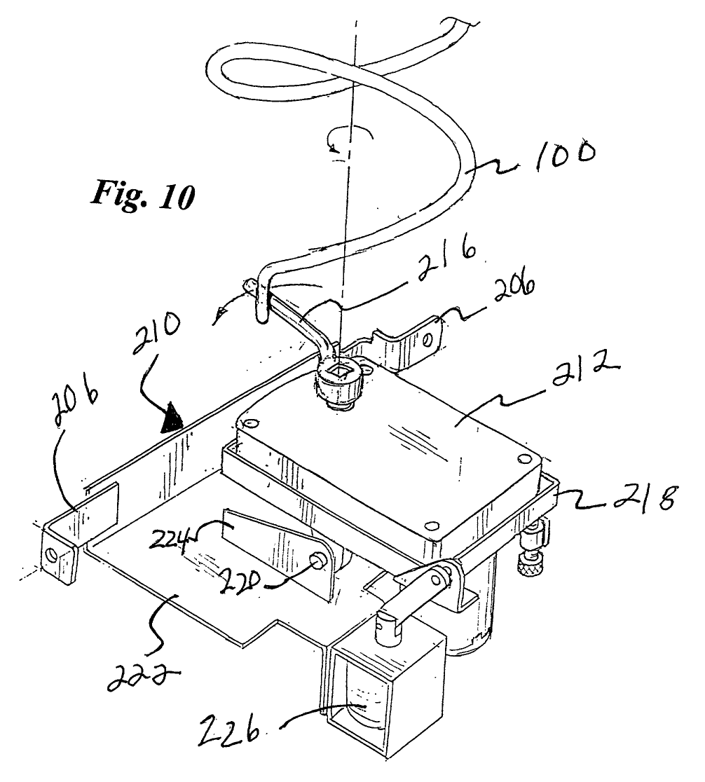

17. FIG. 9 is a perspective view of the second embodiment motorized dispenser positioned for movement between helical coils with the engagement position shown in phantom; and

18. FIG. 10 is a perspective view of the second embodiment motorized dispenser in engagement with the helical coil, with motion of both the actuated vend motor arm and the helical coil indicated.

### DETAILED DESCRIPTION OF THE CURRENTLY PREFERRED EMBODIMENTS

19. Understanding of the invention will be further enhanced by referring to the following illustrative but non-limiting example.

20. A cabinet type coordinate selectable vending machine is disclosed having a single dispenser, with a single vend motor drive attached, for selecting from a plurality of items to be dispensed. In both embodiments, a primary dispenser moves to a vending site rather than having a vend motor for each vending site. In the first embodiment, the primary dispenser, with a single vend motor, is moved to the pre-selected position by a system of threaded rods, one a vertically positioned rod and one a horizontally positioned rod, for dispensing a particular item. Each threaded rod is driven by its' respective drive motor which rotates the respective rod as a worm gear. Because the horizontally positioned rod is mounted my means of a nut follower at either end, to a vertically positioned rod, rotation of the horizontal positioned rod does not cause either of the vertical rods to twist. Rotation of the motor driven vertically positioned rod causes it to move either upwardly or downwardly in response. Rotation of the horizontally positioned rod moves the dispenser, mounted thereto, to the pre-selected position in a horizontal plane, the pair of vertical rods stabilizing and preventing twisting of the horizontally positioned rod. Sensor emitters, mounted adjacent a helical coil, send a signal received by a sensor receptor, mounted on the dispenser, when the dispenser is in the pre-selected position adjacent the respective helical coil. The in-position dispenser, with accompanying vend motor, powers the selected helical coil dispensing the desired article.

21. In the second embodiment, a generally I-shaped support carries the dispenser having a single vend motor mounted thereon. The I-shaped support is in turn carried by a track positioned horizontally below the I-shaped support within the vending machine. The I-shaped support is also supported by a horizontal bar positioned above the I-shaped support. Upon receipt of electrical signals, the dispenser is moved horizontally along the track and then vertically by a pulley system to a selected position whereupon the vend motor mounted on the dispenser is moved into engagement with the selected helical coil. A vend motor arm engages and end of the selected helical coil, or other article storage means, and rotates the helical coil vending the selected article.

22. Turning now to the drawings, in which like reference characters refer to corresponding elements throughout the several views, FIG. 1 illustrates a typical coordinate selectable vending machine 20. The vending machine 20 has a clear panel 21 through which a user may see the items for purchase suspended by a series of helical coils 100, or other vending shelf arrangement. By inserting money into the money receptacle 23 and selecting the item by identifying the item by means of the alphabetic keyboard 24 and the numeric keyboard 26, the vending machine 20 dispenses the selected item into a trough 22 for access by the machine user. A coin return is indicated at 28. The vending machine 20 is powered by means of an electrical cord 29.

23. FIG. 2 is a simplified internal view of the first embodiment vending machine 20 of the current invention with parts removed for ease of understanding. Both embodiments use the same kind of vend motor. In FIG. 2, primary dispenser 30, with a gear box 76, has mounted thereon a single vend motor 31, in actual use conditions a Model #2593 24 volt electric motor, made by Molin, Inc., Chicago, Ill., has been used although any motor which produces sufficient power to rotate a helical coil 100 carrying a vend article in a weight range between a few ounces to a pound, could be used. In this embodiment, adjacent to primary dispenser 30 is a secondary dispenser 30′, also with a vend motor 31′ mounted thereon. Secondary dispenser 30′ serves as a back-up dispenser for use when primary dispenser 30 or it's respective vend motor 31 malfunctions. The vending machine 20 dispenses using only one dispenser, either primary 30 or secondary 30′, and could in fact be used without the backup dispenser 30′. Secondary dispenser 30′ functions entirely in the same manner as the primary dispenser 30.

24. As shown in FIG. 2, dispenser 30 is attached to a nut 32 that is mounted for movement in a horizontal plane on horizontally positioned rod 40. Horizontally positioned rod 40, of tubular shape and of chromium-plated steel or other metals or hard plastic, has a threaded exterior so that horizontally positioned rod 40 functions as a worm gear when powered by horizontal drive motor 80. Nut 32, mounted on horizontally positioned rod 40, has a pair of apertures 48, one at each end of nut 32 for receiving horizontally positioned rod 40. Mounted at a first end of horizontally positioned rod 40 is position wheel 92, such one made by Newark or Granger, which accurately positions dispenser 30 adjacent the selected helical coil 100. Apertures 48 are of a size to threadedly accept outside diameter of horizontally positioned rod 40. Rotational movement of horizontally positioned rod 40, indicated by arrows, screws nut 32 and attached dispenser 30 as a follower causing movement of dispenser 30, along the horizontal plane. Bushings 56 prevent twisting of dispenser 30 about horizontal rod 40. Once the dispenser 30 is positioned adjacent the pre-selected helical coil 100, the dispenser 30 is urged to an engaging position for rotating the selected helical coil 100. In actual use conditions, rectangular-shaped nut 32 is of steel tubing materials although any other resilient materials, such as other metals, hard plastic or ceramics could be used to form a nut 32 or bracket able to support dispenser 30 and be able to be mounted to horizontal rod 40.

25. A pair of nut followers 44, one mounted on each end of horizontal bar 40, provide attachment of horizontal bar 40 to a pair of chromium-plated steel, tubular-shaped, vertical bars 50, 52. Of the pair of vertical bars, at least the first vertical bar 50 has a threaded exterior. In the first embodiment, both vertical bars 50,52 have a threaded exterior. This pair of nut followers 44, or metal bushings, each a thin metal tube for use as a bearing, allow vertical bar 50 to rotate about a Y-axis, pulling horizontally positioned bar 40 upwardly or downwardly in response. In actual use conditions, steel bushings have been used but any suitable bushing, such as plastic or nylon, could be used. Vertical bar 50 may rotate without twisting horizontally positioned bar 40 because of nut followers 44 mounted at the ends of horizontal bar 40.

26. A vertical drive motor assembly 82 is positioned atop vertical bar 50, and powered through powered spring cord 88, drives vertical bar 50 to rotate in a Y-axis in response to an electrical signal received from a LED 110. A second vertical bar 52 also rotates in response to vertical drive motor assembly 82 by means of a transfer case 84 which transfers the motion of bar 50 to vertical bar 52 by a synchronizing transfer rod 86 which is received at a second end thereof by transfer case 84′. Horizontally positioned bar 40 remains in a horizontal plane because vertical rods 50,52 rotate each end of horizontally positioned bar 40 synchronously, raising or lowering horizontally positioned bar 40. Use of the pair of vertical bars 50,52 provides stability to movement of dispenser 30.

27. Mounted on an upper surface of support 42 are a series of infra red producing emitters 60. A specified emitter 60 sends a signal in response to a LED 110 command received through power spring cord 62. Such a signal constitutes an infra red beam. This beam, not shown, is received by the sensors 34, or 34′, and is used to align the dispenser 30 with a selected helical coil 100. Sensors 34,34′ are powered through spring cord 35. The dispenser 30 moves in response to the LED 110 command to a position where the infra red receiving sensors 34, or 34′, receive the signal from the pre-selected emitter 60, stopping the dispenser 30 adjacent the selected helical coil 100. Emitters 60 are associated with each helical coil 100. These emitters 60 are moveable to accommodate different sized helical coils 100 used with different sized articles for vending. Different sized articles are positioned within a row of helical coils 100. The sensor receptors 34, mounted on dispenser 30, signals when dispenser 30 is in the pre-selected position to dispense or vend the selected article. A vertical row of sensor receptors 166 are positioned such that they can sense a different row of helical coils 100 by emitters 58 mounted on horizontal bar 40.

28. In both embodiments, a conventional electronic coin changer money receptacle 23 and multi-pricing unit LED 110 is provided to actuate the dispenser 30, although a single-pricing, non-LED unit could be used. In actual use conditions, a model 9302L LED, as made by Coinco, of St. Louis, Mo., has been used although any logic-type LED could be used. This LED has a transformer that transforms the electrical power from 110 volts to 24 volts DC. This reduction in electrical circuit enables contact to be made with the circuitry without a dangerous electrical charge being received by the repair person. This is an important innovation.

29. As shown in FIG. 2, the first embodiment dispenser 30 is mounted by means of nut 32 onto horizontally positioned rod 40. Dispenser 30 moves horizontally in the X axis in response to rotational movement of horizontally position rod 40, indicated by arrows. Actuation of the drive motor 80 drives dispenser 30 horizontally along the bar 40. Solenoid 70 actuates, shown in detail in FIG. 3, to pivot dispenser 30 to its out of the way position prior to movement of dispenser 30 to the desired position, for actuation of the selected helical coil 100, as shown at FIG. 3. Once in position, dispenser 30 pivots into position in contact with the selected helical coil 100 and the selected helical coil is electronically actuated by means of one of the helical coil docking vend motor systems as shown in FIGS. 4-7. Actuation of switch 96 powers secondary dispenser 30′ into position if primary dispenser 30 is disabled.

30. A sensor 34′ is mounted on dispenser 30′ to receive signals from emitters 60 arranged to indicate a selected row. When actuated, secondary dispenser 34′ is moved into position by horizontally positioned rod 40 which in turn is carried by rotation of vertical bar 50 to the selected row. Vertical bar 50 continues to rotate until a cut-off switch is actuated upon receipt by sensor 34 of infra red signal from activated emitter 60.

31. In both embodiments, electronic controller board 114 consists of a circuit board having a computer chip therein. The circuit board interfaces between LED 110 and which ever dispenser 30 or 30′ is actuated.

32. In the first embodiment, the pair of vertical rods 50, 52, in actual use conditions, of tubular shape and of chromium-plated steel, or of hard plastic, have a threaded exterior so that both vertical bars 50,52 function as worm gears. Threaded vertical rod 50 rotates in response to a second drive motor 80′, in the manner described above. Actuation of threaded vertical bar 50 carries the horizontally positioned rod 40, and the following dispenser 30, vertically to the selected position for vending of the selected article. A nut follower 44 attaches horizontally positioned rod 40 to both vertical bars 50,52.

33. This first embodiment provides a second dispenser 30′, with accompanying sensor 34′, mounted adjacent the first dispenser 30 and, when actuated by a switch 96 within the cabinet 19, acts as a back-up to dispenser 30. Any description herein regarding movement of dispenser 30 appliers equally to secondary dispenser 30′ when actuated. Switch 96 shuts off primary dispenser 30 and activates secondary dispenser 30′ and causing secondary dispenser 30′ to move into position. When secondary dispenser 30′ is actuated, a second solenoid engages and causes dispenser 30′ to shift horizontally to the position formerly held by dispenser 30. In large vending machines, a sensor can be provided to sense when the primary dispenser 30 is not operating and automatically switch on the secondary dispenser 30′. The electrical/mechanical components are shown here generally at 106.

34. Attachment of dispenser 30 to the selected helical coil 100 is described and shown in FIG. 3. In FIG. 3, a close-up view of the motorized dispenser of the present invention taken along the lines 3—3 in FIG. 2, a helical coil 100 is shown with a vend article 102 in place, the assembly supported by a shelf 104. Dispenser 30 is shown in its position of use in contact with and for powering helical coil 100. In phantom is shown dispenser 30 in its out-of-way position disengaged from helical coil 100 for transfer of dispenser 30 to its next position of use.

35. Rotational output shank 120 is shown generally here and in detail in FIG. 4. Rotational output shank 120 provides the engagement of helical coil 100 by vend motor 31 mounted on dispenser 30 that powers helical coil 100 in its rotation whereby vend article 102 is dispensed. Stem 130 is provided mounted on helical coil 100 as a stop once a complete rotation by helical coil 100 has been made. Stem 130 stops helical coil 100 by coming in contact with interposer 134 mounted on L-shaped bracket 132 by which dispenser 30 is mounted to nut 32. Once a selected helical coil 100 is actuated by dispenser 30, helical coil 100 makes a 360 degree rotation and would continue to turn but for the stem 130 coming in contact with interposer 134 which acts as a stop. A link terminal 136 mounted opposite bracket 132 on dispenser 30 provides an attachment point for link 138 that moves dispenser 30 either into engagement with helical coil 100, as shown, or out of the engagement with helical coil 100, as shown in phantom, link 138 either pulling or pushing dispenser 30 in response to movement of solenoid 70 powered by motor 140. Solenoid 70 is mounted on nut 32. Solenoid 70 also actuates a gear track 144 to pivot dispenser 30 to its′ out of the way position prior to movement of the dispenser 30 to the next desired position.

36. L-shaped bracket 132 is mounted to dispenser 30 by screws, although rivets, welds, etc. and other fasteners, could be used to enable the dispenser 30 to be urged to an out of the way position out of engagement with any helical coil to a position in a range of 5-15 degrees from engagement, although 10-12 degrees has been found to work well, and re-positioned to a next-selected helical coil 100.

37. Solenoid 70 is in electrical communication with dispenser 30 so that when solenoid 70 is actuated, it engages dispenser 30, which engages pre-selected helical coil 100 turning helical coil 100 to vend the selected article stored thereupon.

38. Funnel-shaped actuator 90, shown at FIG. 2, is mounted on a rear side of dispenser 30, receives a first end of the helical coil 100 for rotating the helical coil 100 which dispenses an article from a storage position on helical coil 100 into a vend chute, not shown, for receipt by the user. FIG. 2 shows dispenser 30 in its first, at rest position, in phantom. This is the normal rest position for dispenser 30. Dispenser 30 is shown in its position of use, actuated and moved to the selected position for vending an article.

39. In both embodiments, circuitry between LED 110 and electronic controller board 114 in actual use conditions is 26 gauge wire although other gauge wires could be used so long as they can carry the load without endangering the repair person. The circuitry is held in place by a harness which prevents the vend motor from becoming entangled in the circuitry.

40. FIG. 4 illustrates a first helical coil/dispenser docking system with a funnel shaped actuator 90 mounted on an end of shank 122 mounted to and driven by dispenser 30. Here a female dock fitting 124 receives a male end 126 of helical coil 100.

41. FIG. 5 is a second helical coil/dispenser docking system with a slotted head tip 150 of helical coil 100 received by a rotational output shank 120 of dispenser 30.

42. FIG. 6 is a third helical coil/dispenser docking system wherein a yoke hook 170 is mounted on the rotational output shank 120″ to receive an end of helical coil 100.

43. FIG. 7 is a fourth helical coil/dispenser docking system having a yoke 160 is mounted on the rotational output shank 120 and receives an end of helical coil 100.

44. The second embodiment, shown in detail at FIGS. 8-10, again utilizes a dispenser 210 with a single vend motor 212 for vending any article from any horizontal shelf withing the vending machine 20. In this embodiment, the dispenser 210 is moved along an X-Y axis by an I-shaped support 200, as shown in FIG. 8. Support 200, of heavy plastic, ceramic or metal, moves horizontally along a toothed track, or power rail 180. Sprocket 182, such as one made by Inch Drive Corp., rotationally mounted on support 200 drives dispenser 210 as it moves along toothed track 180 in response to electrical signals, supplied by means of electric cord 184, in actual use a toothed track made by Lightning Corporation is used although other track means could be utilized. Because dispenser 210 is a follower of support 200, dispenser 210 moves horizontally with support 200.

45. Flexible toothed band 202, such as a timing belt, made by Inch Drive Components, is mounted for movement on support 200 and provides vertical movement to support 200 and to the follower dispenser 210. Belt pulley 192, powered by electrical cord 194, drives flexible toothed band 202, with dispenser 210, along a vertical plane in response to electrical signals received from electronic controller board 114.

46. Horizontal bar 190 prevents I-shaped support 200 from twisting or otherwise coming out of alignment with track 180. A proximal end of support 196 is mounted by bushings 198 onto horizontal bar 130 allowing support 150 to move horizontally yet stabilizing support 150.

47. As shown in FIG. 8, vend motor 212, mounted on dispenser 210, is powered by electric cord 214 in response to electrical signals received by electronic control board 114. Dispenser 210 is mounted to flexible toothed band 202 by fastening means such as a nut and bolt 204, through an aperture formed in support flange 206, although other fastening means could be used. In this embodiment, vend motor 212 has mounted thereon an arm 216 that rotates 360° when in position to engage a selected helical coil 100 or other vending shelf arrangement, causing the selected article to be vended or dropped into trough 22.

48. As shown in FIG. 10, vend motor 212 is mounted to dispenser 210 by pivoting arm 218 that is further attached by mounting means such as screws to dispenser plate 222. Pivoting arm 218 pivots around a pair of pins 220 mounted on fins 224 on support plate 222. Pivoting arm 218 pivots vend motor 212 in response to a solenoid 226 from a first position, out of the way of the helical coils 100 shown at FIG. 9, to a second position in engagement with helical coil 100, shown in phantom in FIG. 9 and shown in FIG. 10. Movement of arm 216 is indicated in FIG. 10 with corresponding, following movement of helical coil 100.

49. In use, in the first embodiment, in response to money being put into the vending machine at receptor 23, the LED 110 sends a message to the electronic controller board 114 regarding which selection has been made. The electronic controller board 114, which actuates, by means of conventional circuitry, the dispenser 30. Dispenser 30, mounted on the threaded horizontally positioned rod 40 for horizontal movement, moves horizontally until a first sensor 34, mounted adjacent dispenser 30, receives a signal from one of several horizontally placed emitters 60. This signal stops the dispenser's 30 horizontal movement. The horizontally positioned rod 40 is mounted on a threaded vertical rod 50 for vertical movement, vertical bar 52 acting as a stabilizer, the dispenser 30 moves vertically in response to actuation by the LED until the dispenser 30 receives a signal from a vertically mounted emitter 60, the signal stopping the dispenser 30 vertical movement. Dispenser 30 operates at this location to vend the desired article. After the push button is pushed on a selector panels 24,26, by the customer, a momentary pause occurs allowing powering up of and re-location of the dispenser 30. In actual use conditions, vending of the selected article takes place approximately five (5) seconds after deposit of money into the LED change box. After vending an article, dispenser 30 returns to a rest position.

50. When repair is necessary, easy access to replace dispenser 30 is made by pulling out a helical coil shelf 104 and simply manually plugging in the new dispenser 30 as compared to existing vending machines which require the back of the vending machine to be removed and a variety of tools to accomplish repair. Being able to access the dispenser 30 mount from the front is a distinct advantage. Also, being able to pull out the damaged dispenser 30 and replacing it by plugging in a new motor is a distinct advantage.

51. Simple installation of the dispenser 30 is a further object of this invention. Additionally, because a single vend motor is required rather than a dozen or more conventionally 30, or 60 or more vend motors, a single vend motor in a dispenser 30 of the current application, or at most, two with the back-up dispenser, vend motors of higher quality may be economically used.

52. It is an object of the invention to provide a power source which uses a small amount of electrical power such that contact by the repair person with the electrical circuits does not pose a hazard to the repair person. Either embodiments of this invention could also be retro-fit into and existing vending machine.

53. It is an advantage of both embodiments of the present invention in that they use only one vend motor mounted on a dispenser. The first embodiment has a second dispenser with a second vend motor as a back-up. In either case, manufacture of the vending machine of the present invention is more economic to make. Additionally, because, in the first embodiment, the dispenser 30 is mounted on an easily accessible horizontally positioned rod 40, no tools are required to install a new dispenser 30. Additionally, the dispenser 30 is located for easy access by repair person. Although a secondary dispenser 30′ is ordinary provided and found to be acceptable, a vending machine having a single dispenser 30 could also be provided.

54. Both embodiments of the present invention utilizes a plurality of helical coils with one dispenser 30, 210. The dispenser 30, 210 moves and the helical coils 100 are stationary until actuated. The dispenser 30 goes up or down until aligned with appropriate helical coil 100 which it then actuates by receiving an end of the helical coil 100 by a funnel shaped actuator 90 mounted on the dispenser 30 which drives the helical coil 100 resulting in dispensing of the article or an arm 216 rotates helical coil 100.

55. In use, in the second embodiment, in response to money being put into the vending machine at receptor 23, the LED 110 sends a message to the electronic controller board 114 regarding which selection has been made. The electronic controller board 114, which actuates, by means of conventional circuitry, the dispenser 210 to move to the desired location. Dispenser 210, mounted on the I-shaped support 200 for both vertical and horizontal movement, moves horizontally on toothed track 180. No brakes are required to aid in the positioning of dispenser 210 at the selected helical coil 100. The horizontally positioned rod 190 is mounted to stabilize dispenser 210. Vertical movement of dispenser 210, and follower vend motor 212 is accomplished by gear 182 driving flexible toothed band 180 with carrier dispenser 210 and associated vend motor 212. Dispenser 210 operates at this location to vend the desired article. After the push button is pushed on a selector panels 24,26, by the customer, a momentary pause occurs allowing powering up of and re-location of the dispenser 210. In actual use conditions, vending of the selected article takes place approximately five (5) seconds after deposit of money into the LED change box. After vending an article, dispenser 210 returns to a rest position.

56. Because a normal vend motor, operating at 16-21 rpm at 24 volts, makes about 40,000 cycles or vends in a lifetime and with an average cycles-per-day in a snack machine is 50 cycles, this results in about 18,000 cycles per year. The average motor lasts over two years. Having one vend motor per machine greatly reduces the cost of the machine both in manufacturing costs and repair costs.

57. It is understood that although helical coils are shown as the vending shelf in these figures, other means of holding articles are included and adaptable for use with this invention. It is further understood that the single vend motor dispenser system, along with the means for moving the dispenser, could be retro-fit into existing vending machines. This would be especially easy with vending machines using helical coils.

58. Although the present invention has been described in considerable detail with reference to certain preferred versions thereof, other versions are possible. Therefore, the spirit and scope of the appended claims should not be limited to the description of the preferred versions contained herein.

What is claimed is:

1. A vending machine, having a cabinet, and a series of helical coils for holding articles to be vended mounted generally horizontally therein, an electronic controller board and a coin sensing unit, for selectively dispensing articles, comprising:
a) a brake-free dispenser, having a single vend motor as means for actuating a selected helical coil for dispensing any selected article within the vending machine, said dispenser mounted for horizontal and vertical movement within the vending machine; and
b) means for moving said dispenser into engagement with a selected helical coil for dispensing a selected article.

2. The vending machine of claim 1, wherein said means for vertical movement of said dispenser in first embodiment further comprise a pair of threaded vertical bars positioned apart from each other and positioned for rotational movement when actuated, said pair of threaded vertical bars providing stability to movement of said dispenser.

3. The vending machine of claim, wherein said means for horizontal movement further comprises a threaded horizontal bar positioned to support said dispenser, said dispenser a follower to said horizontal bar, said horizontal bar mounted for rotational movement when actuated, and received at each end thereof by one of said pair of vertical bars such that said horizontal bar is supported by said pair of vertical bars.

4. The vending machine of claim 3, further comprising a first drive motor positioned for driving said pair of threaded vertical bars for rotation in a vertical plane.

5. The vending machine of claim 4, further comprising a second drive motor positioned for driving said threaded horizontal bar for rotation in a horizontal plane.

6. The vending machine of claim 5, further comprising actuation means for actuating each of said drive motors such that said dispenser is urged to a selected position.

7. The vending machine of claim 6, further comprising signaling means indicating when said dispenser is in a selected position.

8. The vending machine of claim 7, further comprising receiver means for receiving signaling means for stopping said dispenser when it reaches a selected position.

9. The vending machine of claim 8, further comprising dispenser actuation means for urging said dispenser to a second position in contact with a selected helical coil such that actuation of said dispenser engages and rotates the selected helical coil for dispensing the selected article.

10. The device of claim 9, further comprising a second dispenser mounted adjacent first dispenser, such that, when actuated, said second dispenser is a backup in case of malfunction of said first dispenser.

11. The device of claim 10, further comprising actuation means for activating said second dispenser.

12. The vending machine of claim 1, wherein means for vertical movement of said dispenser in a second embodiment further comprises a dispenser support means.

13. The vending machine of claim 12, wherein means for vertical movement of said dispenser further comprises a horizontal track for receiving dispenser support means.

14. The vending machine of claim 13, wherein said dispenser support means further include an I-shaped housing adapted for horizontal movement along said horizontal track.

15. The vending machine of claim 14, wherein means for vertical movement of said dispenser further comprise a pulley system that moves said dispenser mounted on said I-shaped housing.
